(19) United States
(12) Patent Application Publication
(10) Pub. No.: US 2001/0037454 A1
(43) Pub. Date: Nov. 1, 2001

(54) Computer networked system and method of digital file management and authentication

(76) Inventors: John T. Botti, Loudonville, NY (US); Nicholas Themelis, Muttontown, NY (US); Michael Wolf, Albany, NY (US)

Correspondence Address: Drew M. Wintringham, Chadbourne & Parke LLP, 30 Rockefeller Plaza, New York, NY, 10112, US

(21) Appl. No.: 09/729,411

(22) Filed: Dec. 4, 2000

Related U.S. Application Data
(63) Continuation-in-part of application No. 09/562,735, filed on May 1, 2000.

(51) Int. Cl. H04L 9/00; G06F 17/30

(52) U.S. Cl. 713/176; 707/200; 705/51; 713/161; 713/165; 707/10

(57) ABSTRACT

The digital file management system and method of the present invention provides a processing service that may be located remotely on a computer network that receives digital files from users and performs file identification, authentication and verification, including time and digital signature. The system and method may include the remote processing and storage of file information such that the user does not need to maintain any application specific software at the user's local site. The system and method may record additional independent data with each stored file including: a “true date” gleaned from a secure clock which is not settable by the user (the Authentidate™); a number derived from a cyclic redundancy code (CRC) algorithm or checksum routine against the file; and a CRC or checksum derived from the “true date”, (the “date CRC”). This additional data may be recorded within each digital file after the file is acquired. If the file is altered after the recording of the additional data, recalculation of the CRC on the altered file will not match the original CRC recorded within it. Thus, that the file was altered can be detected. Likewise, if the true date is altered in any way, recalculation of the date CRC will similarly reveal this fact. The CRCs can be checked and verified at any time. If the recalculated value matches the recorded value, the file can be verified as being recorded on the specified date and has not been altered since that time.

This application is a continuation-in-part of U.S. patent application Ser. No. 09/562,735 filed on May 1, 2000.

### FIELD OF THE INVENTION

This invention relates generally to digital file authentication systems and more particularly to digital file signature and time stamp creation and verification.

### BACKGROUND OF THE INVENTION

Digital files, or digital documents, are used to represent various types of information in a digital format. For example, an audio file may be used to hold information for the playing of music, an image file may contain a picture, an executable file may hold instructions for a microprocessor, etc. A computer-readable medium, such as a magnetic hard drive, CD-ROM, DVD, magnetic tape, etc., may be used to store digital files. The storage of information in digital files is increasingly used in many industries, partly because of the increased availability of enabling technology and partly due to the many advantages offered over conventional storage methods including: reduced storage space, increased access speed, focused retrievability (e.g., search capabilities), the ability to conveniently make “multiple” and “backup” copies of documents, and the ability to transfer or transmit documents quickly.

One drawback of storing information in digital files is the inherent ability of digital files to be altered, for example, with a purpose to defraud. For example, although an original paper document can be tampered with, such tampering (erasure or additions) will typically leave telltale evidence; digital representations of those documents, in the form of word processor documents or digital images for example, can be altered leaving no such evidence. Thus, where the authenticity of information is critical and may come into question (e.g., legal and medical fields), use of digital information is often not preferred, not acceptable or not admissible and therefore often avoided.

A computer user may wish to ensure that files are not altered. A proposed solution is the use of Write-Once, Read-Many (“WORM”) optical media to files. One advantage of WORM media storage is that the data it houses is inherently unalterable-data can be written only one time to the medium. However, this approach has several disadvantages as well. For example, data recorded on WORM media can be copied from the WORM disk of original recording to re-writable media, altered, and then recorded on new WORM disk with no traceability of such events.

Additionally, although it can be stated with great confidence that data on any one particular WORM disk has not been altered since it was recorded on that disk, the date and time when the data was recorded or whether the data matches an “original” of any kind cannot be determined with any certain or definitive means.

A known advance in file verification technology provides for registration of an “electronic signature” of a digital file. It is known to allow a user to locally select a file and locally run a program provided by a service provider to create an “electronic signature” of the selected digital file based solely on file content. The signature along with a user-provided file name and user-selected keywords are uploaded to the provider's site and stored in a registration database maintained by the service provider under an account established for the particular user. One particular provider generates a “certificate of registration” showing, inter alia, the signature.

Verification of content and submittal date of the digital file at a later time requires accessing the service provider's site and retrieving the prior registration record by file name or keywords. The retrieved database record shows the file signature and the original date that the file signature was registered. To complete verification, an electronic signature routine is performed on the file to be verified and a comparison between the regenerated signature and the retrieved registered signature is made to determine whether the signature of the digital file in question matches that of the originally registered file. What the user now has is verification that the signature of the file in hand matches the signature of a file which was registered on a particular date.

One disadvantage of this whole process is that the user must take the time to register the files. Another disadvantage is that a user may forget to register files at desired times. Yet another disadvantage is that a user may be undependable—a user intent on corrupting a file may purposely wait to register a file after it has been corrupted.

### SUMMARY AND OBJECTS OF THE INVENTION

The foregoing and other problems and deficiencies in file authentication are solved and a technical advance is achieved by the present invention for providing digital file authentication with automatic registration.

In various aspects, it is among the objects of the present invention to provide a system and method for digital file management and authentication providing automatic digital file registration.

A digital file management system in one embodiment of the present invention comprises means for inputting a digital file and a secure date and time reference providing date and time information. A date/time value is generated which is derived from the secure date and time information. A digital signature is derived from the digital file itself. The digital signature and date/time value (time stamp) are stored.

Alternative embodiments can include such features as generating the date/time value and digital signature by a cyclic redundancy code algorithm and transforming the date/time value and image value via a mathematical transformation.

In some embodiments, the digital signature of a file or files is generated locally, and the digital signature is sent without the digital file to a remote server, where a time stamp is created. Preferably, the time stamp is both archived in a database and sent back to the local system.

In other embodiments, the file is sent to a remote server, where both a digital signature and a time stamp are generated. Preferably, the digital signature and time stamp are archived in a database and also sent back to the local system. The remote server may discard the digital file it received, forward the file to a third party, or archive it.

In other embodiments, the present invention may advantageously work in conjunction with a public key infrastructure (PKI) certificate. A user key, such as a VeriSign™ user key, and a hash code of a file are sent to a remote server, where both a digital signature of the user key and hash code and a time stamp are generated.

### BRIEF DESCRIPTION OF THE DRAWINGS

The foregoing and other features and advantages of the present invention will become more apparent in light of the following detailed description of exemplary embodiments thereof, as illustrated in the accompanying drawings, where

FIG. 1 illustrates a network based implementation according to an embodiment of the invention;

FIG. 2 is a flow chart illustrating the steps of an embodiment of the present invention.

FIG. 3 illustrates a network based implementation of the invention in which a customer site may configure the system or incorporate the system within an operating system for seamless transparent implementation of the system.

FIG. 4 is a flow chart illustrating the steps of an embodiment of the present invention in which the service is automatically implemented.

### DETAILED DESCRIPTION OF THE INVENTION

The following description of the present invention illustrates several preferred embodiments wherein digital files are automatically submitted for verification without the need for user intervention. It is assumed that a computer administrator has already performed the required steps to install up the automatic system described in the present invention, or that application software with function calls capable of performing the described invention has been installed. Although user intervention is not required each time a registration is performed, it is also assumed that, in some preferred embodiments, a user may have some degree of control over whether the automatic feature is turned on or off.

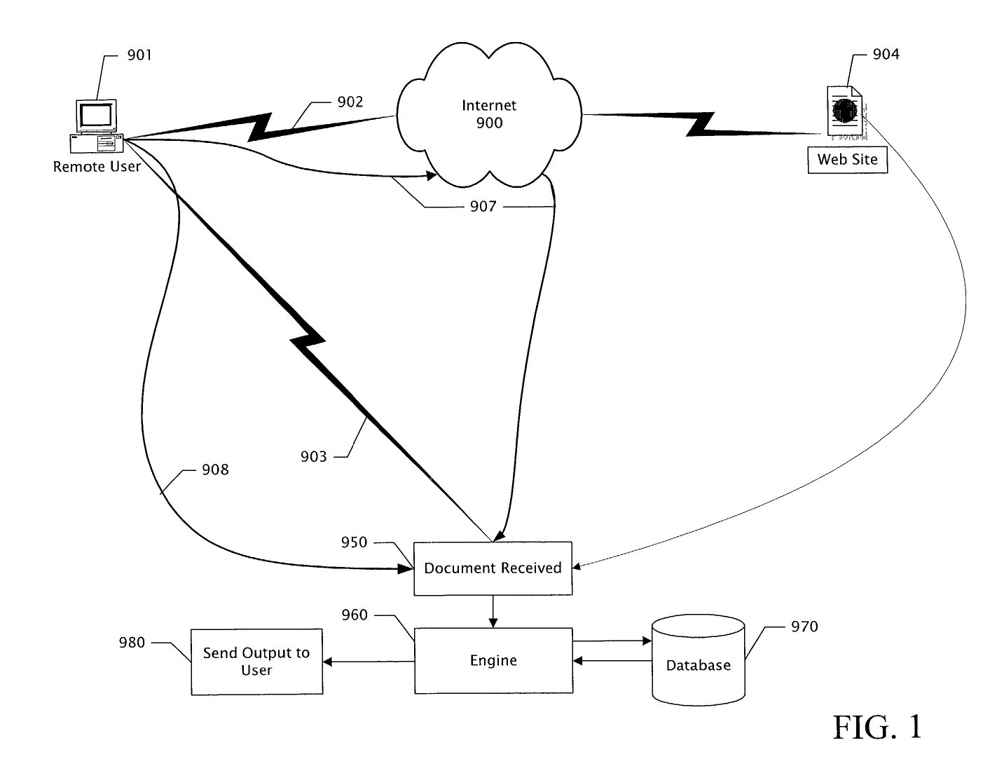

As shown in FIG. 1, a preferred embodiment of the present invention includes using a computer network environment such as the Internet 900. A user 901 may link to an Authentidate™ server 906 by an Internet connection. An example of an Authentidate server 906 is a computer resource that provides Authentidate services such as determining a digital signature of a digital file, determining a time stamp associated with a digital file, or other processes as described herein. The computer network could be a Local Area Network (“LAN”), a Wide Area Network (“WAN”), contained behind a firewall, a part of a larger computer network connected to the Internet, or combinations thereof.

The user 901 has software that automatically connects to the Authentidate server 906. Exemplary methods of connecting to the Authentidate server 906 is shown in FIG. 1, and includes Internet connection 902 to a web site 904 maintained by the Authentidate server 906; a direct dial-in connection 903 to the Authentidate server 906 by, for example, a modem connection; submission of a document to the Authentidate server 906 by e-mail 907; and submission to the Authentidate server 906 by facsimile transmission 908. The email connection 907 is illustrated as an email system that uses the Internet 900 to transmit data. It is also possible to use an email connection that does not use the infrastructure of the Internet 900. Other connections could include wireless connections, links through dedicated computer connections, dedicated hardwire connections, or any other methods for connecting to a computer server or uploading digital documents as are known in the art.

The user's document or file to be verified may be, for example, stored on the local computer's disk drive, the local computer's floppy disk drive, a server or network to which the user's computer is attached, or any other source to which the user has access.

The file is automatically uploaded to be processed (box 950). The Authentidate server 906 may maintain all of the software and hardware to perform the service, which may be referred to generally as the engine 960. The engine 960 obtains a fingerprint or digital signature of the user's document by running a digital signature program or routine on the document, such as a cyclical redundancy code. Digital signature routines are known in the art and any routine may be selected for implementation into the system. A more detailed description of digital signature routines may be found in U.S. patent application Ser. No. 09/562,735 entitled “Computer Networked System and Method of Digital File Management and Authentication”, filed on May 1, 2000. In a preferred embodiment publicly available digital signature routines such as MD-5 or SHA-1 by way of example only may be used (although more advanced publicly available digital signature routines may become available), and in an alternative embodiment a proprietary digital signature routine such as CRC-32 by way of example only may be used. After the engine 960 has obtained the digital signature of the document, the engine 960 may record the signature in a database 970.

The Authentidate server 906 may maintain a master clock in order to accurately determine the time at which documents or files are delivered to the server. For example, an atomic clock which tracks Greenwich Mean Time (GMT) may be used to provide a robust and accurate time stamp for each file that is processed according to the present invention. Other clocks may be used for the purpose of recording a time stamp for each document processed, provided it is maintained for consistency and accuracy. The clock does not have to record GMT. Any time zone will suffice, so long as it is clearly specified. The time stamp may include a date, a time of day, a combination, or any other desired time criteria.

According to an embodiment of the invention, the time stamp is determined at the Authentidate server 906 as the time and date that the document was received by the Authentidate server 906 according to a master time clock at the Authentidate server 906 that is tied, for example, to an atomic clock for accuracy.

An alternative way to record a time stamp may be to record a number that represents a quantity of units of time from a selected date. For example, in the Unix Operating system, an integer number is used to record time represented as the number of seconds measured from a specific point in time. In a similar manner, the Authentidate server 906 could record a number that represents the number of minutes, the number of seconds, or some other unit of time, from a predefined point in time. For example, the time stamp could be a number that represents the total minutes from Jan. 1, 2000 at 12:00 am. The unit of measure may be chosen depending upon the degree of accuracy desired in the time stamp. For example, if time accurate to the second is desired, then the unit should represent seconds. If more or less accuracy is needed, then the unit should be smaller or larger as desired.

The Authentidate server 906 may send a record or receipt to the user who submitted the document, as indicated by box 980. The record may include, for example, the filename by which the document was submitted to the Authentidate server 906, a document identification number (ID Number) or identification tag, the time stamp, the digital signature, and a Reference field. The reference field may be specified by the user or alternatively, by the Authentidate server 906. For example, the reference field could be the subject line of a letter, the title of an agreement, a key phrase, or other suitable information that will be stored. The reference field may be useful in performing a search for the document.

The ID Number may be assigned by the Authentidate server 906 as a unique identifier for every document received by the Authentidate server 906. The ID Number, for example, could be a sequential number assigned incrementally as documents are received. It may be alphanumeric if desired, and may have information encoded, such as the year or date. By way of a non-limiting example, the ID Number may be coded by date, such as 052500-500 which could indicate the 500^{th} document received on May 25, 2000. The ID Number is not required for the present system to operate but rather, is one method which may be used for identification of documents.

Some alternative way of identifying documents rather than providing an ID number may be used. Providing a unique identification tag to a document is all that is needed, whether it is an ID number, a name, or some other unique tag means, it should be unique from other identification tags. Thus, for future reference, the ID number or identification tag is sufficient to allow the Authentidate server 906 to locate information that has been stored for a document. Alternative identification tags could include, for example, that documents or files may be tagged using the filename by which the document was provided to the Authentidate server 906 (which may or may not be unique from all other files uploaded) in combination with, for example, the time, date, or user associated with the uploaded document. The above elements may be re-hashed to provide additional authenticating features.

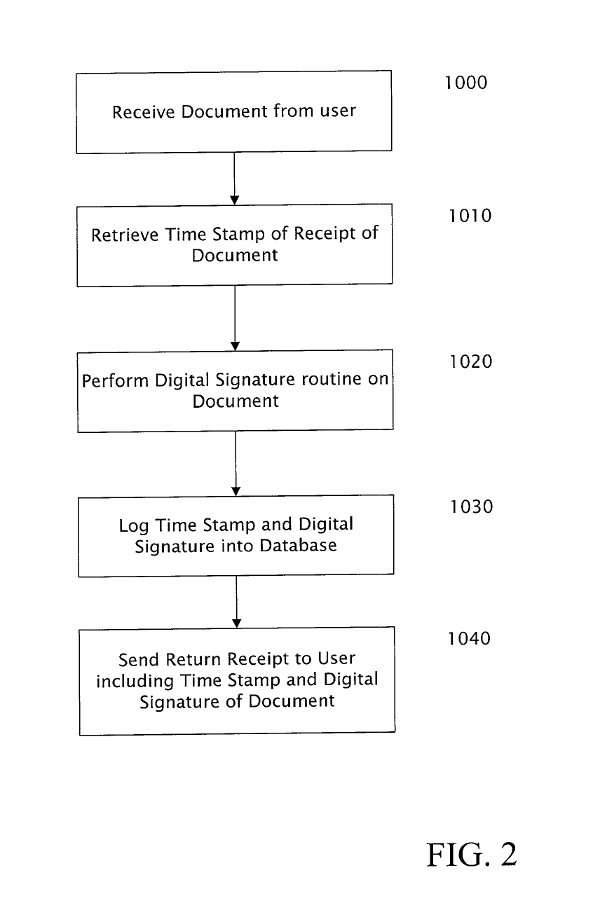

FIG. 2 shows a flow diagram of a preferred embodiment of the present invention. The flow diagram shows exemplary steps, for which an actual implementation could include only some of, as well as, additional process steps, for the engine 960 of FIG. 1. The Authentidate process includes receiving a document from a user (step 1000). When the document is received, the engine 960 will retrieve the time stamp to note the time of receipt of the document (step 1010). The engine 960 also performs the step of obtaining the digital signature of the document (step 1020). The information, that is, the time stamp and the digital signature, along with any other information that may be desirable, such as a document ID number, user identification information, or other document parameters, will be stored in a database maintained by the Authentidate service provider (step 1030). The engine, according to this embodiment, may also send a receipt to the user which includes the pertinent information relating to the submitted document, including, for example, the time stamp, the digital signature, the document ID number, or other information as desired (step 1040). The information could be provided to the user in any number of ways, including, without limitation, providing a web page with the users unique information, sending the receipt to the user via email, returning an information file over the users modem dial-in connection, or sending a receipt via U.S. Mail.

According to a preferred embodiment of the invention, the Authentidate server 906 may maintain a digital copy of the file as submitted in its entirety. The file could be saved in association with the log of information to be kept on the file such as the ID number, the time stamp and the digital signature. Alternatively, the digital document itself is not saved nor maintained by the Authentidate server 906. After the document has been processed in order to derive its digital signature, the document may be returned or deleted. For this alternative, a digital copy of the document is not maintained at the Authentidate site and the user is responsible for maintaining a digital copy of the document. In the future, the user or any third party (i.e. a second user) may submit a digital copy of the document, and the Authentidate server 906 can verify if the newly submitted document is the same as the document originally submitted by the user, and further can verify the date upon which the original document was originally submitted.

To verify whether a digital copy of a document is the same as the original document submitted by the user on the date and time recorded in the log, the Authentidate server 906 runs the digital signature routine on the document to be verified. This second digital signature is compared against the original digital signature, and if they are the same, then the Authentidate server 906 will issue notice that the document is verified. If the digital signatures are not the same, then the Authentidate server 906 will issue notice that the document is not verified.

A user wishing to verify a document may submit the document to Authentidate and request verification. The verifying user may submit the documents via Internet connection, direct dial modem, email, or any other way discussed above for the original user or known in the art. The verifying user may provide the Authentidate server 906 with the ID number of the original document (perhaps received from the original user that submitted the document), the file name, or some other identifying method by which the Authentidate server 906 may obtain the fingerprint of the original document. Authentidate may then run the digital signature program on the recently submitted digital copy of the document, and compare it with the digital signature or fingerprint of the originally submitted document. If the fingerprints compare favorably, then Authentidate will inform the third party that the document submitted matches the document as originally filed on the specified date.

According to a preferred embodiment of the invention, some users may elect to have the original document stored by the Authentidate service. The Authentidate service would then be able to supply copies to the user or third parties upon request in the future. Along with a copy of the original document, the Authentidate service will be able to provide verification of the date upon which the document was submitted. The Authentidate service may require proper security authorization before distributing copies of any documents in order to provide security and maintain privileges of the original user.

It should be recognized that the process steps may occur in any appropriate order. For example, when a document is received, the time stamp may be determined and logged at that time, followed by running of the fingerprint routine, followed by logging of the document's fingerprint. Alternatively, the document may be received, the fingerprint may be determined, and then the time stamp and fingerprint may be logged substantially simultaneously.

As a further level of integrity and verification, the Authentidate server 906 may also perform digital signature routines on log files or database files generated by the Authentidate server 960 that contain the user information of various submitted documents. For example, the Authentidate server 906 may create a log file or database file that contains documents processed for a given period of time, such as a day or hour. For each document submitted and processed during the given time frame, the Authentidate server 906 records information such as the document ID, the user's name, the digital signature of the document, or any other information or parameters as discussed above.

The Authentidate server 906 may then perform a digital signature routine on the log file itself, and store the digital signature of the log file. At a later time, when a user wishes to verify a document for which a record was stored in the log file, the log file must be verified by comparing its digital signature to the digital signature of that log file at the time of storage of the information. Just as with the documents submitted by users, if the digital signature of the log file as originally stored matches the digital signature of the log file at the time of verification, then the log file is verified and the records stored for each of the various documents written to that log file are thus verified. If the log file digital signatures do not match, then the integrity of the log file has been compromised and the data contained therein (which includes the stored digital signature of user files) can not be relied upon. This level of integrity can be used, for example, to guard against tampering with the data.

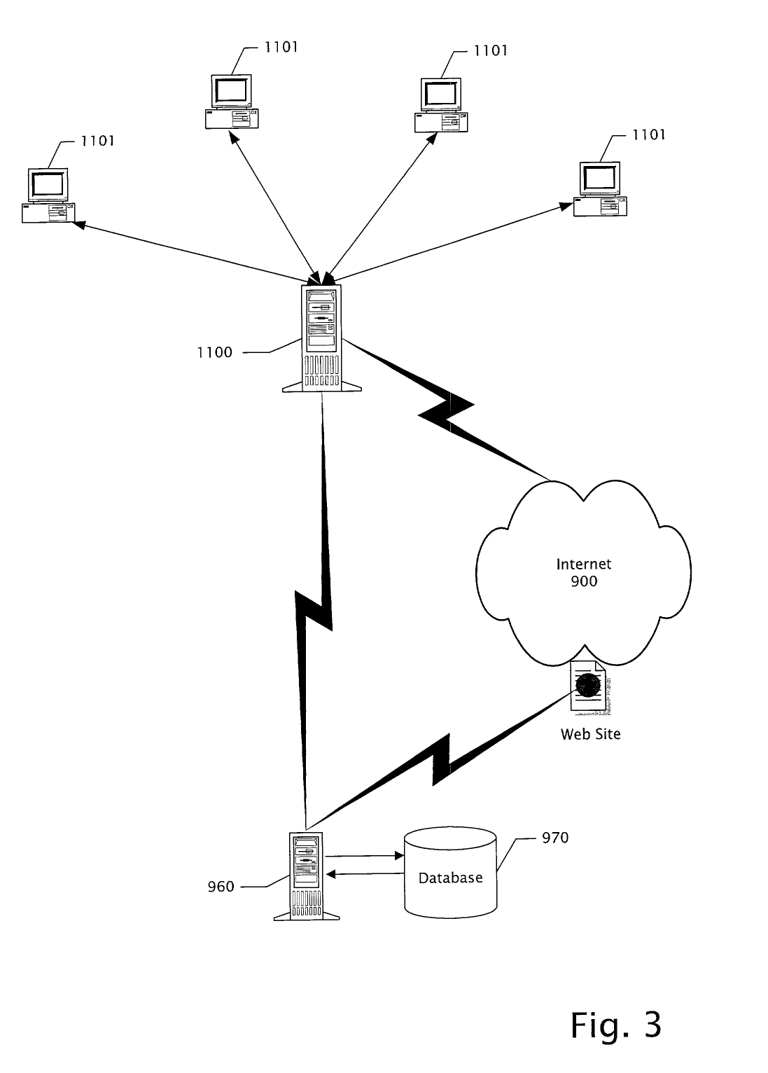

According to a preferred embodiment of the present invention, the system is implemented such that individual users within an organization may seamlessly access the services of an Authentidate server 906 without explicitly performing any steps to activate the process. For example, referring to FIG. 3, the system for performing the steps (such as steps 1000 to 1040 of FIG. 2) to determine the digital signature and time stamp for a document are configured to activate automatically upon execution of routine procedures not explicitly associated with the Authentidate system.

By way of example only, steps in the Authentidate process may be activated by being linked to a word processing program that users 1101 routinely access on the user system or customer site 1100. A program operated on the user system 1100, or on the individual user's workstations 1101, may be configured to recognize events such as execution of third party software routines (e.g. saving a document in a word processing routine as mentioned above) or passage of specified periods of time.

A customer could be an individual having access to the Authentidate server 906, or, for example, a company or other organization or body, that enlists Authentidate services for its employees or members. The customer may set up a user account whereby Authentidate services are provided and performed for digital files on the customer's computer network without the requirement for individuals 1101 at the customer's site 1100 to perform any specific procedures or steps to initiate the Authentidate service. The individuals 1101 at the customer's site do not have to be aware that the service is being implemented. The individuals do not have to be concerned with following certain protocols or operating specific software. For example, when a document on the user's computer system has been modified some predetermined number of times (e.g., from one to any selected number), the Authentidate system may detect such an event and automatically perform the desired steps of the Authentidate service.

The system may be selectable and configurable by the customer. For example, it is contemplated that different customers will desire different features or characteristics of the Authentidate services. A system administrator at a customer site 1100, for example, may configure the Authentidate system to activate every tenth or twentieth time a document is modified and saved on the customer system. The individual at the customer site need not perform any additional steps or procedures other than, for example, the normal steps in the user's word processing program for saving the document. The system administrator, however, may configure the system on the customer's site to detect the occurrence of events on the customer's system and invoke the Authentidate process. The system administrator could elect various other parameters by which to automatically activate the Authentidate services including, by way of non-limiting examples, using the extension of file names as a means of selecting files upon which to perform processing, by automatically implementing the system at a given time of the day or week for any files that have been modified since the last processing, by selecting certain directories or storage devices on the customer site upon which to perform the Authentidate services, or by selecting files based upon working project or department designations used within the customer's organization. A software developer's kit may contain function calls that allow an application to, in a preferred embodiment, perform the Authentidate services upon the occurrence of an event, such as, by way of examples only, the saving of a file, the compilation of source code, or reaching a high score in a game. Such a feature may be implemented using an API. In another preferred embodiment, an application may perform the Authentidate services at periodic intervals.

In a preferred embodiment, the system could be configured to send the digital files to a remote Authentidate server 906 where the Authentidate server 906 determines the digital signature of the document, obtains the time stamp associated with the document, sends a receipt to the customer, and performs other of the steps discussed above, as desired by the customer.

Authentidate services may be performed without sending the digital file to the Authentidate server to be authenticated. Such an implementation has several advantages, such as using less bandwidth. In a preferred embodiment, a system could be configured to determine a digital signature locally and send the digital signature to a remote Authentidate server 906 where the Authentidate server 906 combines the digital signature with a secure time stamp, sends a receipt to the customer, and performs other of the steps discussed above, as desired by the customer. In an alternative preferred embodiment, a system could be configured to determine a digital signature locally and time stamp locally, send the digital signature to a remote Authentidate server 906 where the Authentidate server 906 combines the digital signature with a secure time stamp, sends a receipt to the customer, and performs other of the steps discussed above, as desired by the customer. Preferably, in situations where the Authentidate server does not provide a secure time stamp, the Authentidate server nonetheless performs some verification process on the time stamp, such as comparing the time stamp to the time that the digital signature and time stamp are received by the Authentidate server. By way of example only, the Authentidate server could provide a time window (such as 20 minutes) for which any time stamp received will match the clock on the Authentidate server (or other reliable clock). In such an implementation, the Authentidate server could reject a time stamp that is outside the time window.

Any of the above discussed methods for processing and storing digital files and digital signatures may be implemented seemlessly without requiring the user to invoke special procedures, follow protocols, or take additional steps beyond those typically used to operate the applications with which the user customarily encounters. For example, the use of the save command on a word processing routine may automatically invoke services without a user doing more.

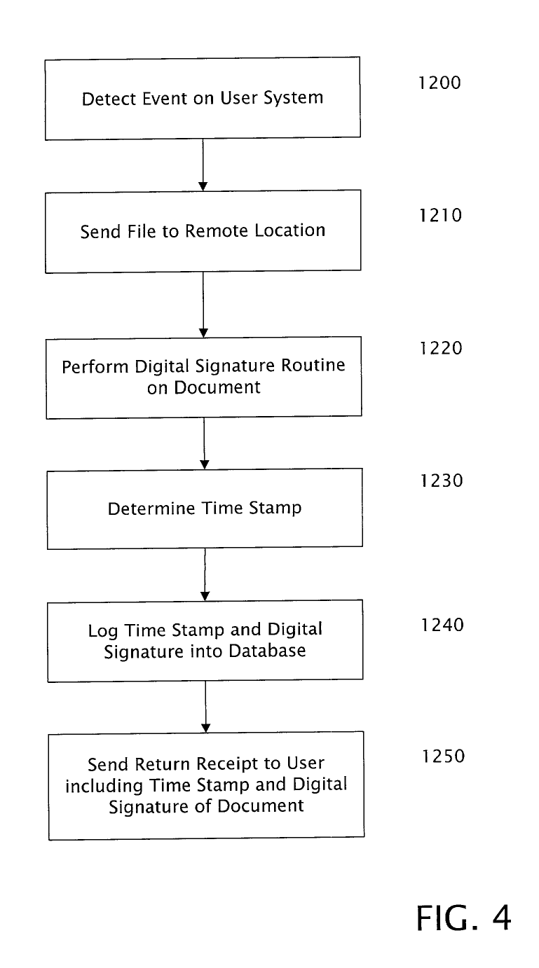

For example, with reference to FIG. 4, one embodiment of the present invention is to have the program recognize an event (step 1200), such as every twentieth time that a document is saved by a user 1101 accessing a word processor or other third party program on the user system 1100, or at the end of each business day, detect every document that was edited on the user system 1100. Once an event is detected, then a file or files will be automatically processed by the system. The user 1101 does not have to take any action. According to the implementation of FIG. 4, the system will send the file or files to a remote location (e.g. Authentidate server 906) for further processing (step 1210).

At the remote location, a digital signature routine (step 1220) and time stamp (step 1230) are determined and then stored in a database (step 1240). The system will then send a return receipt to the user providing the digital signature and time stamp (step 1250).

The system could be set up to perform all the services locally, in order to maintain the security of sensitive documents, creating a log file of document IDs, digital signatures, or other information as desired. The system could then send the log file to a remote location to be processed and stored at a remote location. At the remote location, the log file is combined with a secure time stamp. This insures the integrity of the log file and allows for the security provided by having files remain local to the user site.

The system could also be used as a document storage and archiving system. The customer could send digital files to the Authentidate remote location, or another remote storage location, for storage of files. The digital files may have a digital signature routine performed upon them, along with the association of a time stamp corresponding to submission of the digital file or document. The Authentidate service specified by the user may include storage of the original document for archival purposes, such that, at a later time, the customer may submit a request for the document. The Authentidate service then may provides a digital copy of the document to the user, along with other information such as a verification that it is a true and accurate copy of the document, the date upon which the document was submitted for archiving, or other information concerning the document.

The customer site 1100 may communicate with the Authentidate server 906 by any appropriate or known connection means, which includes, for example, connecting through the Internet 900 to a web site maintained by the Authentidate, or by having a direct connection to the Authentidate server 906, such as a direct dial-in modem connection, a facsimile submission of documents, or other known means of transmitting digital files. The documents may be submitted by email as discussed above in reference to FIG. 1.

A further embodiment of the present invention is to incorporate or imbed Authentidate software for performing the Authentidate process into operating system or network software. The functions and operations of the Authentidate service, such as detecting events on the customer system, performing local digital signature routines, verifying files, sending files for remote processing, or processing files locally and sending a log file containing digital signatures to be stored and time stamped, may be seemlessly integrated into operating system software to enhance availability, robustness, ease of operation, and stability of the Authentidate service, and promote widespread dissemination of the products and services of the system while also reducing costs and complexity of implementing the system.

The present invention has been illustrated and described with respect to specific embodiments thereof. It is to be understood, however, that the above-described embodiments are merely illustrative of the principles of the invention and are not intended to be exclusive embodiments.

Alternative embodiments capturing variations in the enumerated embodiments disclosed herein can be implemented to achieve the benefits of the present invention.

It should further be understood that the foregoing and many various modifications, omissions and additions may be devised by one skilled in the art without departing from the spirit and scope of the invention.

It is therefore intended that the present invention is not limited to the disclosed embodiments but should be defined in accordance with the claims which follow.

What is claimed is:

1. A method for registering at least one digital file, the method comprising the steps of:
a) recognizing an occurrence of an event on a computer system;
b) in response to said occurrence of said event, performing a digital signature routine on said at least one digital file to obtain a digital signature of said at least one digital file;
c) creating a time stamp corresponding to the time of submission of said at least one digital file; and
d) sending said digital signature and said time stamp to a remote location;
wherein a user on said computer system does not need to perform any act exclusive to the method in order to cause the method to automatically execute.

2. The method according to claim 1, wherein said occurrence of said event is the execution of a command in a third party software program maintained on said computer system.

3. The method according to claim 2, wherein said occurrence of said event is a specified number of occurrences of said execution of said command in said third party software program.

4. The method according to claim 2, wherein said occurrence of said event is the saving of a document in a word processing program.

5. The method according to claim 1, wherein said occurrence of said event is the passage of a specified amount of time.

6. The method according to claim 1, wherein said occurrence of said event is a specified time of day.

7. The method according to claim 1, wherein said at least one digital file is a class of digital files.

8. The method according to claim 7 wherein said class of digital files is identified by a filename extension.

9. The method according to claim 7 wherein the class of digital files is identified by a storage location on said computer system.

10. The method according to claim 7 wherein said class of digital files is identified by a project designation at said computer system.

11. The method according to claim 7 wherein member digital files of said class of digital files are digital files that have been modified during a period of time.

12. The method according to claim 1, further including the step of receiving a receipt, the receipt including said time stamp, said digital signature, and an identifier of said at least one digital file.

13. The method of claim 1, wherein said time stamp includes at least a time of day and a date.

14. The method of claim 1, wherein said time stamp includes a number representing a quantity of units of measure of time from a predetermined point in time.

15. The method according to claim 14, wherein said number represents a quantity of seconds from a predetermined point in time.

16. The method of claim 1, wherein said digital signature routine is a checksum routine.

17. The method of claim 1, wherein said digital signature routine is a cyclic redundancy code routine.

18. The method of claim 1, wherein said digital signature routine is a publicly available encryption routine.

19. The method of claim 1, wherein said digital signature routine is a proprietary encryption routine.

20. The method of claim 1, wherein said event is determined by a function call from a function from a software developer's kit.

21. The method according to claim 1, wherein said occurrence of said event is an operation modifying a digital file on said computer system.

22. The method according to claim 1, wherein said occurrence of said event is an operation upon a digital file on said computer system.

23. A method for registering at least one digital file, the method comprising the steps of:
a) recognizing an occurrence of an event on a computer system; and
b) in response to said occurrence of said event, sending said at least one digital file to a remote location for creation of a digital signature and authenticating time stamp;
wherein a user on the computer system does not need to perform any act exclusive to the method in order to cause the method to automatically execute.

24. The method according to claim 23, wherein said occurrence of said event is the execution of a command in a third party software program maintained on said computer system.

25. The method according to claim 24, wherein said occurrence of said event is a specified number of occurrences of said execution of said command in said third party software program.

26. The method according to claim 23, wherein said occurrence of said event is the saving of a document in a word processing program.

27. The method according to claim 23, wherein said occurrence of said event is the passage of a specified amount of time.

28. The method according to claim 23, wherein said occurrence of said event is a specified time of day.

29. The method according to claim 23, wherein said at least one digital file is a class of digital files.

30. The method according to claim 29 wherein said class of digital files is identified by a filename extension.

31. The method according to claim 29 wherein the class of digital files is identified by a storage location on said computer system.

32. The method according to claim 29 wherein said class of digital files is identified by a project designation at said computer system.

33. The method according to claim 29 wherein member digital files of said class of digital files are digital files that have been modified during a period of time.

34. The method according to claim 23, further including the step of receiving a receipt, the receipt including said time stamp and an identifier of said at least one digital file.

35. The method of claim 23, wherein said time stamp includes at least a time of day and a date.

36. The method of claim 23, wherein said time stamp includes a number representing a quantity of units of measure of time from a predetermined point in time.

37. The method according to claim 36, wherein said number represents a quantity of seconds from a predetermined point in time.

38. The method of claim 23, wherein said event is determined by a function call from a function from a software developer's kit.

39. The method according to claim 23, wherein said occurrence of said event is an operation modifying a digital file on said computer system.

40. The method according to claim 23, wherein said occurrence of said event is an operation upon a digital file on said computer system.

41. A method for registering at least one digital file, the method comprising the steps of:
a) recognizing an occurrence of an event on a computer system; and
b) in response to said occurrence of said event:
i) performing a digital signature routine on said at least one digital file; and
ii) sending said at least one digital file to a remote location for creation of a digital signature and authenticating time stamp;
wherein a user on said computer system does not need to perform any act exclusive to the method in order to cause the method to automatically execute.

42. The method according to claim 41, wherein said sending at least one digital file includes sending a user key.

43. A method for registering at least one digital file, the method comprising the steps of:
a) receiving at a server remote to a computer system a digital signature corresponding to said at least one digital file, said digital signature having been created on said computer system in response to an event at said computer system; and
b) determining a time stamp corresponding to the time of receipt of said digital signature;
wherein a user on said computer system does not need to perform any act exclusive to the method in order to cause said digital signature to be automatically created.

44. The method of claim 43, further comprising the steps of receiving at said remote server a user key and creating a second digital signature based on said user key and first said digital signature.

45. A method for registering at least one digital file, the method comprising the steps of:
a) receiving at a remote server said at least one digital file, said at least one digital file having been sent from a computer system in response to an event at said computer system;
b) performing a digital signature routine on said at least one digital file to obtain a digital signature of said at least one digital file; and
c) determining a time stamp corresponding to the time of receipt of said digital file;
wherein a user on said computer system does not need to perform any act exclusive to the method in order to cause said computer system to send said at least one digital file.

46. The method of claim 45, further comprising the step of receiving at said remote server a user key, and wherein said performing a digital signature routine on said at least one digital file is performing a digital signature routine on said at least one digital file and said user key to obtain a digital signature of said at least one digital file and said user key.

47. The method according to claim 45, wherein said at least one digital file is a class of digital files.

48. The method according to claim 47 wherein said class of digital files is identified by a filename extension.

49. The method according to claim 47 wherein the class of digital files is identified by a storage location on said computer system.

50. The method according to claim 47 wherein said class of digital files is identified by a project designation at said computer system.

51. The method according to claim 47 wherein member digital files of said class of digital files are digital files that have been modified during a period of time.

52. The method according to claim 45, further including the step of sending a receipt, the receipt including said time stamp, said digital signature, and an identifier of said at least one digital file.

53. The method of claim 45, wherein said time stamp includes at least a time of day and a date.

54. The method of claim 45, wherein said time stamp includes a number representing a quantity of units of measure of time from a predetermined point in time.

55. The method according to claim 54, wherein said number represents a quantity of seconds from a predetermined point in time.

56. The method according to claim 45, wherein said digital signature routine is a checksum routine.

57. The method according to claim 45, wherein said digital signature routine is a cyclic redundancy code routine.

58. The method according to claim 45, wherein said digital routine is a publicly available encryption routine.

59. The method according to claim 45, wherein said digital routine is a proprietary encryption routine.

60. The method according to claim 45, wherein said event is determined by a function call from a function from a software developer's kit.

61. The method according to claim 45, wherein steps (b) and (c) are performed a plurality of times to create a plurality of digital signatures and a plurality of digital time stamps, and further comprising the steps of:
d) performing a digital signature routine on said plurality of digital signatures and said plurality of digital time stamps to obtain a superhash digital signature; and
e) determining a time stamp corresponding to the time of creation of said superhash digital signature.

62. The method according to claim 61, further comprising the step of sending said superhash digital signature and said time stamp corresponding to said time of creation to said superhash signature to another server.

63. The method according to claim 45, further comprising the step of storing said digital signature and said time stamp in a database.

64. A method of verifying a second digital file, comprising the steps of claim 63 and further comprising the steps of:
receiving said second digital file;
performing a digital signature routine on said second at least one digital file to obtain a second digital signature;
retrieving said digital signature and said time stamp from said database;
comparing said second digital signature with said digital signature; and
reporting a result from said comparison.

65. The method according to claim 64, further comprising the step of receiving at said remote server a user key, and wherein said performing a digital signature routine on said at least second digital file is performing a digital signature routine on said second at least one digital file and said user key to obtain a second digital signature of said second at least one digital file and said user key.

66. A computer-readable medium having stored thereon a plurality of instructions, said plurality of instructions including instructions which, when executed by a processor, cause said processor to:
a) recognize an occurrence of an event on a computer system;
b) in response to said occurrence of said event, perform a digital signature routine on at least one digital file to obtain a digital signature of said at least one digital file;
c) create a time stamp corresponding to the time of submission of said at least one digital file; and
d) send said digital signature and said time stamp to a remote location;
wherein a user on said computer system does not need to perform any act exclusive to the system in order to cause the method to automatically execute.

67. The computer-readable medium according to claim 66, wherein said plurality of instructions further includes instructions which, when executed by a processor, causes said processor to send a user key to said remote location.

68. A computer-readable medium having stored thereon a plurality of instructions, said plurality of instructions including instructions which, when executed by a processor, cause said processor to:
a) perform a digital signature routine on at least one digital file to obtain a digital signature of said at least one digital file, wherein said at least one digital file was sent from a computer system in response to an event at said computer system; and
b) determine a time stamp corresponding to the time of receipt of said digital file;
wherein a user on said computer system does not need to perform any act exclusive to the system in order to cause said computer system to send said at least one digital file.

69. The computer-readable medium according to claim 68, wherein said performing a digital signature routine on said at least one digital file is performing a digital signature routine on said at least one digital file and a user key to obtain a digital signature of said at least one digital file and said user key.
